(19) United States
(12) Patent Application Publication
(10) Pub. No.: US 2022/0048154 A1
(43) Pub. Date: Feb. 17, 2022

(54) HANDHELD CUTOFF GRINDER

(71) Applicant: Hilti Aktiengesellschaft, Schaan (LI)

(72) Inventors: Helmut SPECHT, Irsee (DE); Stefan TEUFELHART, Bachern (DE); Guenther VEIK, Maeder (AT)

(21) Appl. No.: 17/274,368

(22) PCT Filed: Aug. 28, 2019
(86) PCT No.: PCT/EP2019/072899

§ 371 Date: Mar. 8, 2021

(30) Foreign Application Priority Data
Sep. 10, 2018 (EP) 18020443.0

(51) Int. Cl. B24B 27/08; B24B 41/04; B24B 55/05; B25F 5/02

(52) U.S. Cl. CPC B24B 27/08; B25F 5/021; B24B 55/052; B24B 41/04

(57) ABSTRACT

Handheld cutoff grinder including a cutting disk (11), a motor housing having a drive unit and a cantilever (16) with a support arm (17) and an arm cover (18). A stop element (41) is provided in the arm cover (18) for the spindle (12), the stop element limiting the movement of the spindle (12) in a plane (48) perpendicular to the axis of rotation (13) during operation.

### TECHNICAL FIELD

The present invention relates to a handheld cutoff.

### BACKGROUND

Cutoff grinders are handheld power tools having a machining tool in the form of a rotating cutting disk. The essential components of a cutoff grinder include not only the cutting disk, which is arranged on a spindle and is rotatable about an axis of rotation, but also a motor housing with a drive unit, and a cantilever with a support arm and an arm cover, which is fastened to the support arm by means of fastening elements. The support arm is fixed by a first end on the motor housing and the spindle is fixed on a second end of the support arm by means of a bearing element. The spindle is connected to the drive unit via a transmission device designed as a belt drive. DE 103 25 663 A1 discloses a handheld cutoff grinder of this kind.

In the case of known handheld cutoff grinders, the reaction forces which occur during machining with a handheld cutoff grinder are absorbed by the support arm. The stability and rigidity of the support arm therefore play an important role in the structural design of handheld cutoff grinders; moreover, weight optimization is of fundamental importance with handheld power tools. DE 103 25 663 A1 describes a handheld cutoff grinder with a one-piece design of the support arm, this being intended to lead to higher stability and rigidity as compared with multipart support arms. In order to reduce the weight, numerous openings and recesses are provided in the support arm, wherein the support arm has in the openings and recesses reinforcing struts that increase rigidity.

In the case of handheld cutoff grinders, the cutting depth is an important criterion. EP 3 173 188 A1 describes a handheld cutoff grinder which can achieve an increased cutting depth. For this purpose, however, the support arm must be as compact and delicate in design as possible in the region of its second end. At the same time, a compact and delicate support arm has the disadvantage that the stability and rigidity of the support arm is reduced. Forces which occur at the cutting disk due to machining with the handheld cutoff grinder are transmitted to the support arm via the spindle and the bearing elements thereof. The higher the forces which occur at the cutting disk during machining, the greater is the loading of the support arm.

### SUMMARY OF THE INVENTION

An object of the present invention is to develop a handheld cutoff grinder in such a way that a compact and delicate support arm can withstand high forces. Damage to the support arm should not occur, even in the case of high forces.

According to the invention, the handheld cutoff grinder is characterized in that a stop element is provided in the arm cover for the spindle, wherein the stop element limits the movement of the spindle in a plane perpendicular to the axis of rotation during operation. The stop element makes it possible during the operation of the handheld cutoff grinder to divert at least some of the occurring forces into the arm cover and to reduce the loading of the support arm in the region of its second end.

During the operation of the handheld cutoff grinder, there is a movement of the spindle, which is guided in the support arm by means of one or more bearing elements. The higher the occurring forces, the greater is the movement of the spindle in a plane perpendicular to the axis of rotation of the cutting disk, which coincides with the axis of rotation of the spindle. When the spindle strikes against the stop element, at least some of the occurring forces are transmitted from the spindle to the stop element and are transmitted from the stop element into the arm cover. Since the arm cover is fastened to the support arm by means of the fastening elements, the forces are transmitted once again from the arm cover to the support arm via the fastening elements. The fastening elements are preferably arranged in robustly designed regions of the arm cover and of the support arm.

The stop element for the spindle can be integrated into the arm cover or can be designed as a separate insert element, which is fitted into a bearing seat in the arm cover, or as a bearing element, which is fitted into a bearing seat in the arm cover. The bearing seat for the separate insert element and the bearing seat for the bearing element are preferably integrated into the arm cover. The arm cover is preferably manufactured as a casting from a metal material. In the case of castings, bearing seats, reinforcing struts and other functional elements can be easily integrated.

In a preferred embodiment, the support arm has a first bearing seat and a second bearing seat in the region of the second end, wherein a first bearing element is arranged in the first bearing seat, and a second bearing element is arranged in the second bearing seat. The spindle is mounted on the support arm by means of the first bearing element and the second bearing element, which are arranged spaced apart on the support arm. As compared with a single bearing element, mounting the spindle by means of two mutually spaced bearing elements has the advantage that the tilting moment of the spindle is lower. The greater the distance between the first and second bearing element, the lower the tilting moment of the spindle.

The arm cover is preferably manufactured from a metal material. As compared with conventional arm covers made of plastics, an arm cover made from a metal material has the advantage that, by virtue of the higher modulus of elasticity, occurring forces can be transmitted by the arm cover without the arm cover being damaged.

As a particular preference, the arm cover is preferably manufactured from a light metal material. Suitable light metal materials are aluminium and magnesium, for example. Light metal materials reduce the weight of the arm cover in comparison with metal materials such as steel.

In a preferred embodiment, the stop element is in the form of an insert element, wherein the insert element is arranged in a bearing seat, which is formed in the arm cover. The bearing seat in the arm cover is preferably integrated into the arm cover. By virtue of the design of the stop element as an insert element which is fitted into a bearing seat in the arm cover, wear can be reduced. The choice of materials for the spindle and the insert element can be matched to one another. The matching of the materials is particularly important since the spindle is moved about an axis of rotation relative to the insert element.

In another preferred embodiment, the stop element is in the form of a further bearing element, wherein the further bearing element is arranged in a bearing seat, which is formed in the arm cover. The bearing seat in the arm cover is preferably integrated into the arm cover. Designing the stop element as a further bearing element makes it possible to reduce wear. On the one hand, the choice of materials for the spindle and the further bearing element can be matched to one another. A stop element in the form of a further bearing element, e.g. of a ball bearing, additionally has the advantage that only slight relative movements occur between the spindle and the inside of the ball bearing, and wear is further reduced.

In a preferred embodiment, the spindle is mounted in the support arm by means of the first and second bearing elements and is mounted in the arm cover by means of a further bearing element. During the operation of the handheld cutoff grinder, the further bearing element in the arm cover can transmit forces from the support arm via the spindle as a stop element.

As a particular preference, the first bearing element is designed as a fixed bearing and the further bearing element as a floating bearing for the spindle. Designing the further bearing element in the arm cover as a floating bearing prevents geometric overdetermination for the spindle in the state of rest. The further bearing element is fitted into the bearing seat in the arm cover (interference fit), and the arm cover can be pushed onto the spindle with the further bearing element. The arm cover is then fastened on the support arm by means of the fastening elements.

### BRIEF DESCRIPTIONS OF THE DRAWINGS

Exemplary embodiments of the invention are described hereinafter with reference to the drawing. These are not necessarily intended to show the exemplary embodiments to scale; rather the drawing, where useful for explanation, is produced in a schematic and/or slightly distorted form. It should be taken into account here that various modifications and variations relating to the form and detail of an embodiment may be undertaken without departing from the general concept of the invention. The general concept of the invention is not limited to the exact form or the detail of the preferred embodiment shown and described hereinafter or limited to subject matter that would be limited compared with the subject matter claimed in the claims. For given dimensioning ranges, values within the stated limits should also be disclosed as limit values and can be used and claimed as desired. For the sake of simplicity, the same reference numerals are used below for identical or similar parts or parts with identical or similar functions.

In the figures:

FIGS. 1A, 1B show a handheld cutoff grinder according to the invention having a cutting disk, a motor housing and a cantilever with a mounted arm cover (FIG. 1A) and a dismounted arm cover (FIG. 1B);

FIGS. 2A, 2B show the arm cover of the cantilever in FIG. 1A in a view of the inside with a stop element, which is designed as an insert element (FIG. 2A) or as a bearing element (FIG. 2B); and

FIG. 3 shows the cantilever of the handheld cutoff grinder illustrated in FIG. 1A in a section through the axis of rotation of the spindle on which the cutting disk is arranged.

### DETAILED DESCRIPTION

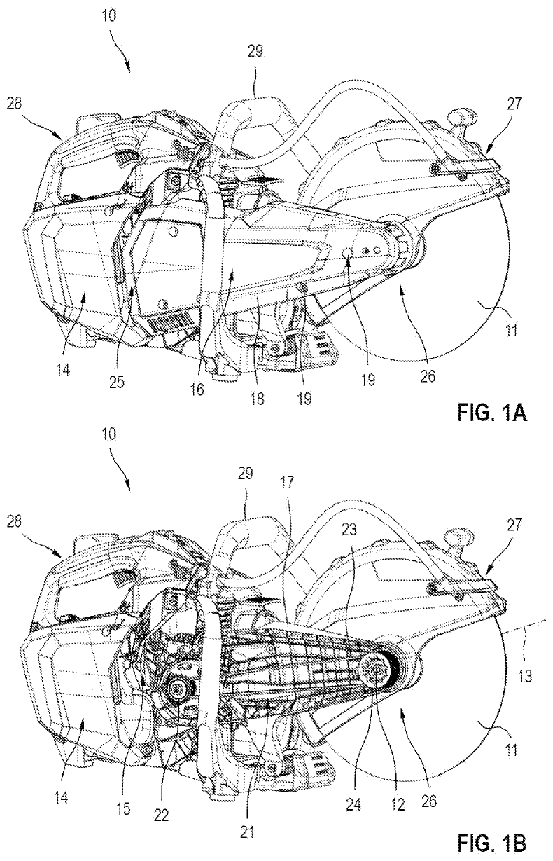

FIGS. 1A, 1B show a handheld power tool 10 according to the invention, which is in the form of a handheld cutoff grinder. The handheld cutoff grinder 10 has a machining tool designed as a cutting disk 11, which is arranged on a spindle 12 and is rotatable about an axis of rotation 13. In addition to the cutting disk 11, the handheld cutoff grinder 10 comprises a motor housing 14 with a drive unit 15 and a cantilever 16 with a support arm 17 and an arm cover 18. The arm cover 18 is fastened to the support arm 17 by means of fastening elements 19, which can be designed as screws. FIG. 1A shows the handheld cutoff grinder 10 with the fastened arm cover 18, and FIG. 1B shows the handheld cutoff grinder 10 without the arm cover 18.

The cutting disk 11 is driven by means of the drive unit 15, a transmission device 21, which is arranged in the cantilever 16 and, in the exemplary embodiment shown, is designed as a belt drive, and the spindle 12. The term “drive unit” includes all drive components which are arranged in the motor housing 14. A drive motor, which is an internal combustion engine in the exemplary embodiment shown, but may also be an electric motor, is arranged in the motor housing 14. Between the drive motor and the belt drive 21 it is possible to arrange a centrifugal clutch, which ensures that the cutting disk 11 does not rotate at low speeds of rotation, e.g. in the idle state or when starting the handheld cutoff grinder 10; moreover, further gear components can be arranged between the drive motor and the transmission device 21.

The drive motor drives an input shaft and an input pulley 22. A transmission element 23 designed as a drive belt is passed over the drive pulley 22 and an output pulley 24 mounted on the spindle 12. The input pulley 22, the drive belt 23, and the output pulley 24 form the belt drive 21. As an alternative to the belt drive, the transmission device 21 can be in the form of a chain drive for example, in which the transmission element between the input pulley 22 and the output pulley 24 is designed not as a drive belt but as a chain.

The transmission device 21 which connects the spindle 12 to the drive unit 15 is arranged in the cantilever 16. The arm cover 18 serves inter alia to cover the rotating components of the transmission device 21 and to reduce the risk of injury posed by the operator reaching into the rotating components of the transmission device 21 during the operation of the handheld cutoff grinder 10. The support arm 17 of the cantilever 16 is fixed at a first end 25 on the motor housing 14 and the spindle 12 is fixed at a second end 26 of the support arm 17 by means of a bearing element, which is not illustrated.

The cutting disk 11 is surrounded by a guard 27, which serves to protect the operator from flying dust particles and furthermore reduces the risk of injury posed by the operator reaching into the rotating cutting disk 11 during the operation of the handheld cutoff grinder 10. For operating the handheld cutoff grinder 10, a first handgrip 28 is provided, which is designed as a top handle and is arranged above the motor housing 14. As an alternative, the first handgrip can be designed as a rear handle, which is arranged on the side of the motor housing 14 which faces away from the cutting disk 11. For guiding the handheld cutoff grinder 10, a second handgrip 29 is provided in addition to the first handgrip 28, the second handgrip being arranged between the cutting disk 11 and the first handgrip 28. In the exemplary embodiment shown in FIGS. 1A, B, the second handgrip 29 is designed as a separate grip tube or, as an alternative, can be formed integrally with the motor housing 14.

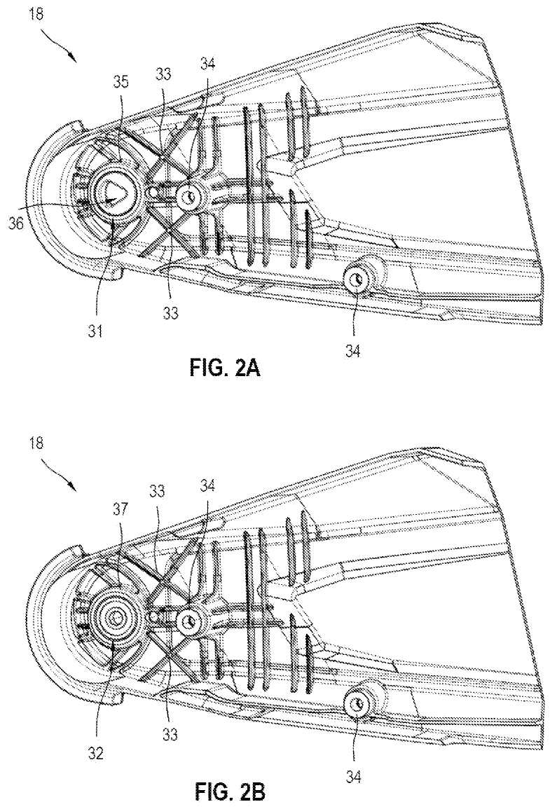

FIGS. 2A, 2B show the arm cover 18 of the cantilever 16 in FIG. 1A in a view of the inside with a stop element which is designed as an insert element 31 (FIG. 2A) or as a bearing element 32 (FIG. 2B).

The arm cover 18 is part of the cantilever 16 and is fastened to the support arm 17 by means of the fastening elements 19, which are designed as screws for example. The arm cover 18 and the support arm 17 can be manufactured as castings from a metal material, in particular as castings made from a light metal material for reasons of weight. In order to increase the stability and rigidity of the arm cover 18, the arm cover 18 has a plurality of reinforcing struts 33.

The use of a metal material for the arm cover 18 makes it possible to introduce forces into the arm cover 18 without the arm cover 18 being damaged. Conventional arm covers for handheld cutoff grinders made of plastic are unsuitable for the introduction of forces because of the lower modulus of elasticity; they serve exclusively for covering the rotating components of the transmission device 21.

During the operation of the handheld cutoff grinder 10, there is a movement of the spindle 12, which is guided in the support arm 17 by means of bearing elements. The higher the occurring forces, the greater is the movement of the spindle 12 in a plane perpendicular to the axis of rotation 13. In order to limit the movement of the spindle 12 in the plane perpendicular to the axis of rotation 13 during operation, a stop element is provided in the region of the second end 26 of the arm cover 18. The stop element makes it possible during the operation of the handheld cutoff grinder 10 to divert some of the occurring forces into the arm cover 18 and thereby to reduce the loading of the support arm 17 in the region of its second end 26. When the spindle 12 strikes against the stop element, at least some of the forces are transmitted from the spindle 12 to the stop element and are transmitted from the stop element into the arm cover 18. Since the arm cover 18 is fastened to the support arm 17 by means of the fastening elements 19 (see FIGS. 1A, 1B), the forces are transmitted once again from the arm cover 18 to the support arm 17 via the fastening elements 19.

The arm cover 18 is fastened to the support arm 17 by means of the fastening elements 19. The transmission of the forces from the arm cover 18 into the support arm 17 likewise takes place via the fastening elements 19. For this purpose, screw bosses 34, into which the screws 19 are screwed, are provided on the arm cover 18. The screw bosses 34 are, in particular, arranged in such a way that the forces are transmitted from the arm cover 18 into robust and stable regions of the support arm 17.

FIG. 2A shows the arm cover 18 with a stop element which is designed as an insert element 31. A bearing seat 35, into which the insert element 31 is fitted, is formed in the arm cover 18. The insert element 31 has an internal contour 36 which serves as a stop surface for the spindle 12 and limits the movement of the spindle 12 in a plane perpendicular to the axis of rotation 13 during the operation of the handheld cutoff grinder 10. In order to limit the wear between the spindle 12 and the insert element 31, the materials of the spindle 12 and the insert element 31 can be matched to one another. The matching of the materials is particularly important since the spindle 12 is moved about an axis of rotation relative to the insert element 31.

FIG. 2B shows the arm cover 18 with a stop element which is designed as a bearing element 32. A bearing seat 37, into which the bearing element 32 is fitted, is formed in the arm cover 18. In order to limit wear between the spindle 12 and the bearing element 32, the materials of the spindle 12 and of the bearing element 32 can be matched to one another. The bearing element 32, e.g. in the form of a ball bearing, additionally has the advantage that only slight relative movements occur between the spindle 12 and the inside of the ball bearing, and wear is further reduced as compared with the insert element 31.

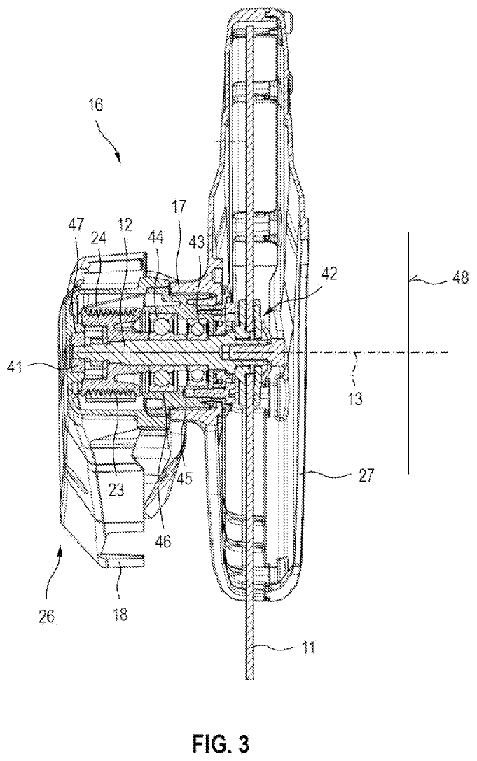

FIG. 3 shows the cantilever 16 of the handheld cutoff grinder 10 in FIG. 1A in a section through the spindle 12, wherein a stop element 41 is provided for the spindle 12 in the arm cover 18. The stop element 41 is designed as a bearing element for the spindle 12 and can be replaced by the bearing element 32 in FIG. 2B, for example.

The handheld cutoff grinder 10 comprises the cutting disk 11, the motor housing 14 with the drive unit 15, and the cantilever 16 with the support arm 17 and the arm cover 18. The cutting disk 11 is secured on the spindle 12 by means of a flange 42 and designed to be rotatable about the axis of rotation 13. The movement of the drive unit 15 is transmitted to the spindle 12 via the input pulley 22, the drive belt 23 and the output pulley 24; the output pulley 24 is arranged on the spindle 12 for conjoint rotation therewith.

The spindle 12 is mounted on the support arm 17 by means of a first bearing element 43 and a second bearing element 44. In the region of its second end 26, the support arm 17 has a first bearing seat 45 and a second bearing seat 46. The first bearing element 43 is fitted into the first bearing seat 45, and the second bearing element 44 is fitted into the second bearing seat 46. As compared with a single bearing element, mounting the spindle 12 by means of the mutually spaced first and second bearing elements 43, 44 has the advantage that the tilting moment of the spindle 12 is lower. The greater the distance between the first and second bearing elements 43, 44, the lower is the tilting moment of the spindle 12.

A bearing seat 47, into which the stop element 41 is fitted, is provided in the arm cover 18. The stop element 41 is designed as a further bearing element for the spindle 12 and is also referred to as the third bearing element. The first bearing element 43 is designed as a fixed bearing for the spindle 12, and the third bearing element 41 is designed as a floating bearing for the spindle 12. Designing the third bearing element 41 in the arm cover 18 as a floating bearing prevents geometric overdetermination for the spindle 12 in the state of rest of the cutoff grinder 10. The third bearing element 41 is fitted into the bearing seat 47 in the arm cover 18 (interference fit), and the arm cover 18 can be pushed onto the spindle 12 with the third bearing element 41. The arm cover 18 is then fastened on the support arm 17 by means of the fastening elements 19. During the operation of the handheld cutoff grinder 10, the stop element 41 limits the movement of the spindle 12 in a plane 48 perpendicular to the axis of rotation 13.

What is claimed is:

1-8. (canceled)

9: A handheld cutoff grinder comprising:
a spindle;
a cutting disk arranged on the spindle and rotatable about an axis of rotation;
a motor housing with a drive unit, the spindle being connected to the drive unit via a transmission device; and
a cantilever with an arm cover and a support arm having a first end and a second end, the support arm being fixed by the first end on the motor housing and the spindle being fixed via a bearing element to the second end,
the arm cover being fastened on the support arm via fasteners;
a stop being provided in the arm cover for the spindle, the stop limiting movement of the spindle in a plane perpendicular to the axis of rotation during operation.

10: The cutoff grinder as recited in claim 9 wherein the support arm has a first bearing seat and a second bearing seat at the second end, a first bearing being arranged in the first bearing seat, and a second bearing being arranged in the second bearing seat.

11: The cutoff grinder as recited in claim 9 wherein the arm cover is a metal material.

12: The cutoff grinder as recited in claim 11 wherein the metal material is a light metal material.

13: The cutoff grinder as recited in claim 9 wherein the stop is an insert, the insert being arranged in a bearing seat formed in the arm cover.

14: The cutoff grinder as recited in claim 9 wherein the stop is a bearing arranged in a bearing seat formed in the arm cover.

15: The cutoff grinder as recited in claim 10 wherein the spindle is mounted in the support arm via the first and second bearings and is mounted in the arm cover via a further bearing.

16: The cutoff grinder as recited in claim 15 wherein the first bearing is designed as a fixed bearing and the further bearing as a floating bearing for the spindle.
